(19) United States
(12) Patent Application Publication
(10) Pub. No.: US 2003/0098991 A1
(43) Pub. Date: May 29, 2003

(54) Autobatching and print job creation

(76) Inventors: Tim Laverty, Seattle, WA (US); Cory Klatt, Edmonds, WA (US); Brent Krum, Redmond, WA (US)

Correspondence Address: BANNER & WITCOFF, 1001 G STREET N W, SUITE 1100, WASHINGTON, DC, 20001, US

(21) Appl. No.: 10/078,543

(22) Filed: Feb. 21, 2002

Related U.S. Application Data
(60) Provisional application No. 60/332,523, filed on Nov. 26, 2001.

(51) Int. Cl. B41J 1/00; G06F 15/00

(52) U.S. Cl. 358/1.15; 358/1.18

(57) ABSTRACT

A system and process for preprocessing print production orders is described. A work order is received by a work order dispatcher and forwarded to a batching system. The batching system combines the work order with other work orders having similar characteristics. The combined work orders are output as a resultant plate. Also, batching may be performed to combine work orders for vendors. Through determination and evaluation of the various characteristics of the work orders, the batching process is automated, thereby minimizing the need to operator intervention.

### RELATED APPLICATION INFORMATION

This application claims priority to U.S. Patent Application Serial No. 60/332,523, entitled “Autobatching and Print Job Creation,” filed Nov. 26, 2001, whose contents are expressly incorporated herein by reference.

This application is also related to U.S. patent applications:

1. U.S. application Ser. No. 09/479,867, to Klatt et al. filed Jan. 10, 2000, entitled “System For Generating Print Production Tasks Using Information Extracted From Enterprise Databases;”

2. U.S. application Ser. No. 09/479,668, to Klatt et al. filed Jan. 10, 2000, entitled “Method Of Generating Print Production Tasks Using Information Extracted From Enterprise Databases;”

3. U.S. application Ser. No. 09/479,669, to Klatt et al. filed Jan. 10, 2000, entitled “System And Method Of Using Human Resources Data To Generate Printed Products;”

4. U.S. application Ser. No. 09/479,918, to Klatt et al. filed Jan. 10, 2000, entitled “System And Method Of Using A Sales Management System To Generate Printed Products;”

5. U.S. application Ser. No. 09/479,917, to Klatt et al. filed Jan. 10, 2000, entitled “System And Method For Generating Reprints;”

6. U.S. application Ser. No. 09/479,916, to Klatt et al. filed Jan. 10, 2000, entitled “User Interface For Establishing Event Rules For Print Orders;”

7. U.S. application Ser. No. 09/479,915, to Klatt et al. filed Jan. 10, 2000, entitled “System For Establishing Event Rules For Print Orders;”

8. U.S. application Ser. No. 09/479,914, to Klatt et al. filed Jan. 10, 2000, entitled “System For Establishing Event Rules For Human Resources Databases;”

9. U.S. application Ser. No. 09/479,913, to Klatt et al. filed Jan. 10, 2000, entitled “System For Establishing Event Rules For Sales Management Databases;”

10. U.S. application Ser. No. 09/479,912, to Klatt et al. filed Jan. 10, 2000, entitled “System For Establishing Event Rules For Publishing;”

11. U.S. application Ser. No. 09/479,911, to Klatt et al. filed Jan. 10, 2000, entitled “System For Establishing Event Rules For Manufacturing And Inventory Management Databases;”

12. U.S. application Ser. No. 09/479,910, to Klatt et al. filed Jan. 10, 2000, entitled “Method For Printing Information Automatically Combined From Two Different Sources;”

13. U.S. application Ser. No. 09/479,909, to Klatt et al. filed Jan. 10, 2000, entitled “Apparatus For Printing Information Automatically Combined From Two Different Sources;”

14. U.S. application Ser. No. 09/479,946, to Klatt et al. filed Jan. 10, 2000, entitled “Method Of Preparing And Approving Printing Information;”

15. U.S. application Ser. No. 09/479,945, to Klatt et al. filed Jan. 10, 2000, entitled “Apparatus For Preparing And Approving Printing Information;”

16. U.S. application Ser. No. 09/480,171, to Klatt et al. filed Jan. 10, 2000, entitled “Method Of Printing Via A Selectable Printing Vendor;”

17. U.S. application Ser. No. 09/480,172, to Klatt et al. filed Jan. 10, 2000, entitled “Apparatus For Printing Via A Selectable Printing Vendor;”

18. U.S. application Ser. No. 09/479,908, to Klatt et al. filed Jan. 10, 2000, entitled “Method Of Employing A Procurement System To Automatically Procure Printing Orders;”

19. U.S. application Ser. No. 09/479,943, to Klatt et al. filed Jan. 10, 2000, entitled “Apparatus For Employing A Procurement System To Automatically Procure Printing Orders;” and

20. U.S. application Ser. No. 09/479,944, to Klatt et al. filed Jan. 10, 2000, entitled “System And Method For Generating Printed Products With Notification.”

### FIELD OF THE INVENTION

The present invention relates generally to printing. More particularly, the present invention relates to preprocessing of print orders to minimize printing inefficiencies.

### BACKGROUND

Businesses contact print vendors to print large quantities of materials. For example, businesses generally require print vendors to print business cards. FIG. 7 shows an environment where a customer sends a print request to a print vendor 702. The print request may include a request for 1000 business cards and letterhead for a new employee. The print vendor is expected by the customer to fulfill the print request within a specified time.

While this generalized process of “receive order/fulfill order” seems straightforward enough, the setup and operation of printing presses (or other related printing systems including lithography, and other know printing process employed by printing shops) are fraught with inefficiencies. For instance, most of the costs of printing business cards are related to the set up of the business cards on a press. However, the price that a print vendor expects to receive in the printing marketplace for business cards is generally tied to the amount of business printed. While a small fee may be charged for the set up of the business cards, a print vendor would generally want to print more business cards at the same time then less. So, if a customer wants 1000 business cards and the print vendor is using a printing press that generates six business cards per impression, the print vendor would want to combine the customer's order with a number of other orders for similar cards to permit the running of the press for 1000 impressions verses only running it for 167 impressions. This process of combining is referred to as batching. Batching multiple requests for each printing plate is conventionally referred to as manual imposition.

A further issue with print vendors is the coordination of print tasks from customers. For example, multiple customers 701, 704, 705, and 706 may send print orders to the print vendor 702. In this situation, the print vendor 702 needs to coordinate the print order. This commonly results in press runs with more than one business card per individual per impression as sorting through multiple print orders is difficult. This then creates an environment where print vendors 702 attempt to process all orders on a “first come/first served” basis. While a print manager 703 may be employed to coordinate between customers 701's and 704-706's print requests, this tedious process of sorting between print orders results in numerous errors and wastes resources of the print vendor 702, thereby decreasing the profit margin of the print vendor 702.

### SUMMARY

Aspects of the present invention address one or more of the problems discussed above. Using the present invention, improved coordination between print requests may be realized.

These and other features of the invention will be apparent upon consideration of the following detailed description of preferred embodiments.

### BRIEF DESCRIPTION OF THE DRAWINGS

The foregoing summary of the invention, as well as the following detailed description of preferred embodiments, is better understood when read in conjunction with the accompanying drawings, which are included by way of example, and not by way of limitation with regard to the claimed invention.

FIG. 1 is an example of a batching system in accordance with aspects of the present invention.

FIG. 2 is an example of a process flow for addressing pending work orders in accordance with aspects of the present invention.

FIG. 3 shows various examples of full plates in accordance with aspects of the present invention.

FIG. 4 shows another example of a process flow for processing work orders in accordance with aspects of the present invention.

FIGS. 5 and 6 show various timings of work order handling in accordance with aspects of the present invention.

FIG. 7 shows conventional work order handling systems.

FIG. 8 shows a process for the job creation center according to aspects of the present invention.

### DETAILED DESCRIPTION

The following description may be grouped into three aspects of automated print job creation. The three aspects include autobatching (the batching of print ready files or work orders), auto job creation (the grouping of work orders), and work order dispatching (the distribution of print ready files or work orders). Some or all of the various components described herein may include various processors with memory and related hardware and supporting software.

Work orders may be defined as requests to perform various tasks. Included in the broad category of work orders are print orders.

Print ready files are electronic files as are known in the art that are in a form ready to be used in a printing process with minimal or no modification. An example of a print ready file is a Postscript file from the Adobe Corporation.

Autobatching, the Batching of Print Ready Files (Work Orders)

Autobatching is an automatic method of combining multiple print ready files together on print ready plates used by print vendors. The vendors may achieve reduced costs by increasing the length of print press run times, for example, by increasing the number of impressions for a press run.

To make the printing process more efficient for print vendors 702, they may accept print ready files from a customer 701. To automate printing of print ready files, the print vendor may provide automatic printing of each print ready file. However, if each print ready file is sent separately, then an automated printing system used by a print vendor 702 may force separate press runs for each print ready file received.

Considering that a large percentage of the cost in printing is press setup time, this solution is not cost effective. If print ready files are combined and run through a press together, costs are significantly reduced.

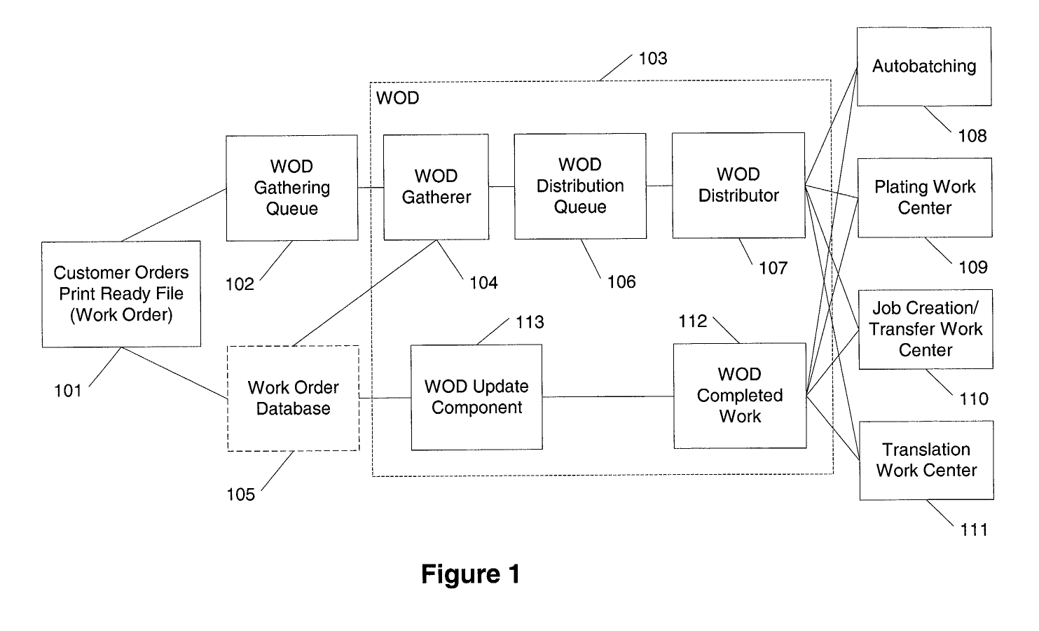

FIG. 1 is an example of a batching system in accordance with aspects of the present invention. The example of FIG. 1 minimizes the reliance on manual imposition. It also attempts to consider a current queue of potential print jobs available for imposition at a given press. It attempts to address the complex task of job scheduling and automation of plate imposition of the print jobs.

Referring to FIG. 1, a customer generates a work order in 101. This work order may take the form of a print ready file. When a print ready file (or work order (WO)) is ordered by a customer, the work order is queued for processing in a work order dispatcher ordering queue 102. The work order WO may include all of the information needed to fulfill the work order. Alternatively, the work order WO may have some of the information needed to complete it stored in a work order database 105. This optional remote storage of information is shown in broken lines. This information stored in 105 may be from previous work orders, may be from the customer 101 directly, or from other sources. The following documents highlight various aspects of remote storage of information and obtaining the information as needed. The following are expressly incorporated herein by reference for any essential subject matter relating to the creation and generation of print requests, and more generally work orders:

1. U.S. application Ser. No. 09/479,867, to Klatt et al. filed Jan. 10, 2000, entitled “System For Generating Print Production Tasks Using Information Extracted From Enterprise Databases;”

2. U.S. application Ser. No. 09/479,668, to Klatt et al. filed Jan. 10, 2000, entitled “Method Of Generating Print Production Tasks Using Information Extracted From Enterprise Databases;”

3. U.S. application Ser. No. 09/479,669, to Klatt et al. filed Jan. 10, 2000, entitled “System And Method Of Using Human Resources Data To Generate Printed Products;”

4. U.S. application Ser. No. 09/479,918, to Klatt et al. filed Jan. 10, 2000, entitled “System And Method Of Using A Sales Management System To Generate Printed Products;”

5. U.S. application Ser. No. 09/479,917, to Klatt et al. filed Jan. 10, 2000, entitled “System And Method For Generating Reprints;”

6. U.S. application Ser. No. 09/479,916, to Klatt et al. filed Jan. 10, 2000, entitled “User Interface For Establishing Event Rules For Print Orders;”

7. U.S. application Ser. No. 09/479,915, to Klatt et al. filed Jan. 10, 2000, entitled “System For Establishing Event Rules For Print Orders;”

8. U.S. application Ser. No. 09/479,914, to Klatt et al. filed Jan. 10, 2000, entitled “System For Establishing Event Rules For Human Resources Databases;”

9. U.S. application Ser. No. 09/479,913, to Klatt et al. filed Jan. 10, 2000, entitled “System For Establishing Event Rules For Sales Management Databases;”

10. U.S. application Ser. No. 09/479,912, to Klatt et al. filed Jan. 10, 2000, entitled “System For Establishing Event Rules For Publishing;”

11. U.S. application Ser. No. 09/479,911, to Klatt et al. filed Jan. 10, 2000, entitled “System For Establishing Event Rules For Manufacturing And Inventory Management Databases;”

12. U.S. application Ser. No. 09/479,910, to Klatt et al. filed Jan. 10, 2000, entitled “Method For Printing Information Automatically Combined From Two Different Sources;”

13. U.S. application Ser. No. 09/479,909, to Klatt et al. filed Jan. 10, 2000, entitled “Apparatus For Printing Information Automatically Combined From Two Different Sources;”

14. U.S. application Ser. No. 09/479,946, to Klatt et al. filed Jan. 10, 2000, entitled “Method Of Preparing And Approving Printing Information;”

15. U.S. application Ser. No. 09/479,945, to Klatt et al. filed Jan. 10, 2000, entitled “Apparatus For Preparing And Approving Printing Information;”

16. U.S. application Ser. No. 09/480,171, to Klatt et al. filed Jan. 10, 2000, entitled “Method Of Printing Via A Selectable Printing Vendor;”

17. U.S. application Ser. No. 09/480,172, to Klatt et al. filed Jan. 10, 2000, entitled “Apparatus For Printing Via A Selectable Printing Vendor;”

18. U.S. application Ser. No. 09/479,908, to Klatt et al. filed Jan. 10, 2000, entitled “Method Of Employing A Procurement System To Automatically Procure Printing Orders;”

19. U.S. application Ser. No. 09/479,943, to Klatt et al. filed Jan. 10, 2000, entitled “Apparatus For Employing A Procurement System To Automatically Procure Printing Orders;” and

20. U.S. application Ser. No. 09/479,944, to Klatt et al. filed Jan. 10, 2000, entitled “System And Method For Generating Printed Products With Notification.”

The work order dispatcher 103 then combines work orders from the work order gathering queue 102 and sends them to various other processing centers including autobatching center 108, plating work center 109, job creation/transfer work center 110, and translation work center 111. The various work centers may include processors in servers or server farms handling the processing tasks of each.

The internal operations of the work order dispatcher 103 are described below. The work order dispatcher gatherer obtains 104 obtains the work orders from the work order gathering queue 102. If needed, additional information may be gathered from the work order database 105. The resultant information is combined. The work order distribution queue 106 obtains the output from the WOD distribution queue 106. Next, the WOD distributor 107 distributes ready work orders to the various work centers 108-111.

The autobatching work center 108 attempts to combine the work orders with other work orders. When relating to printing tasks, the work orders (WOs) may be referred to as print work orders (PWOs). The autobatcher 108 holds print work orders for a specified amount of time (determined using various information including, for example, the required delivery date and an estimate for vendor production time) and combines PWOs together when possible. After combining PWOs into logical batches (or plates) the completed batching work for the PWOs is returned to the work order dispatcher completed work queue 112.

The autobatching work center 108 batches print work orders through use of various rules. All rules may be fixed or not fixed for combining purposes. Alternatively, a combination of rules may be used. The rules may be processed using known processors and programming structures.

As to the combination of rules, immutable batching rules and mutable batching rules maybe used. Immutable batching rules are those rules that never change for all print work orders. Examples of Immutable Batching rules are PWOs must have the same inks to be batched together, PWOs must have the same imposition to be batched together, and PWOs must have the same stock (substrate or paper) to be batched together. A list of immutable batching rules may include one or more of the following (or none as long as the rule is immutable):

1. All positions on plates should be filled unless the products being batched are set to allow open positions.

2. Work Orders will always be batched by Vendor

3. Work Orders will always be batched by like Stock

4. Work Orders will always be batched by like Inks

5. Batching and job creation will always be executed by estimated ship dates (earliest estimated ship dates are batched first, but it is OK to batch two different days together since it is okay to hold orders up to a specific ripeness level that could be greater than one day).

6. Hard code the following sorting of in process work orders order

A. Estimated Ship Date

B. Ship Method Code

C. Ship To Address

Mutable Batching rules are those rules that the system either can learn and implement or a user overrides. Some examples of mutable batching rules are: PWOs can be held by the system for a specific amount of time (waiting for other PWOs that have compatible rules in order to create full plates to increase efficiencies); PWOs must be from the same customer (some customers have exceptionally high volume and need separated for billing or other reasons); and PWOs must have the same estimated delivery date (again some customers wish their items ordered in a specific time period to arrive together). These rules may be specified in a registry for the autobatcher 108 (as preset defaults, as set by the user, or dynamically specified and loaded from the workflow software). Other rules can of course be added to suit the desired outcome. A list of mutable batching rules may include one or more of the following (or none as long as the rule is mutable):

1. Allow for flexibility to manage/define batching by like quantity

2. Allow for flexibility to manage/define batching by similar rush flag

3. Allow for flexibility to manage/define batching ripeness for work orders (Calculated from the customer cutoff date/time).

4. Allow for flexibility to manage/define batching with bulk shipping.

5. Allow for the setting of run times at a customer level. Latency and run-time may be mutually exclusive settings.

6. Allow for flexibility to manage/define whether a print product needs to be batched separately (items with an non-automated workflow).

7. Allow for flexibility to manage/define whether a product runs through an independent workflow outside of the order dispatcher. The rule should signify that the order dispatcher does not process work orders for the product.

8. Allow for flexibility to manage/define whether work orders will be batched with the same estimated delivery date.

As discussed above, manual setup of batching is error prone, uneconomical, and very repetitive. Further, it cannot anticipate and work with the large volumes of print jobs required in high volume throughput of custom print jobs required by online print management systems. The autobatcher 108 takes this repeatable process and automates it for use in such high volume systems.

A number of available software tools can be used to facilitate batching in print systems. Software products such as ScenicSoft's Preps (which can be used to physically produce Plate (batched print ready files) files), and ADD MORE Imposition/Batching SOFTWARE PRODUCTS, each have their own quirks and eccentricities. Each of these tools requires a human to perform the logic of batching. The user of the tool must decide whether an item should be batched now or later (for efficiency), what items can be batched together (and can't), etc. Settings for selection of files, impositions, stock, inks, etc. are proprietary to these systems. These systems therefore require a high level of customization.

Work order settings (mutable rules, inks information, and other settings) may be obtained from a list of settings stored in a printing management system work order database 105 by the WOD Gatherer component 104. Thus, the work order database may include customer information or work order settings or both. Further, two or more databases may be used to store this information.

The WO data is placed in the WOD distribution queue 106. The WO may include in a variety of forms. In some embodiments, the form of the WO may include various mark up languages as are known in the art. One language that may be used, for example, is XML. In this example, the WOD distributor 107 reads the XML routing structure for the WO data placed in the WOD distribution queue 106 and sends the WO data to appropriate work centers (108-111). The transmission process may be through various mediums including over dedicated lines or over the internet. If over the internet, one technique of sending the WO to the various work centers 108-111 is to send the WO by HTTP.

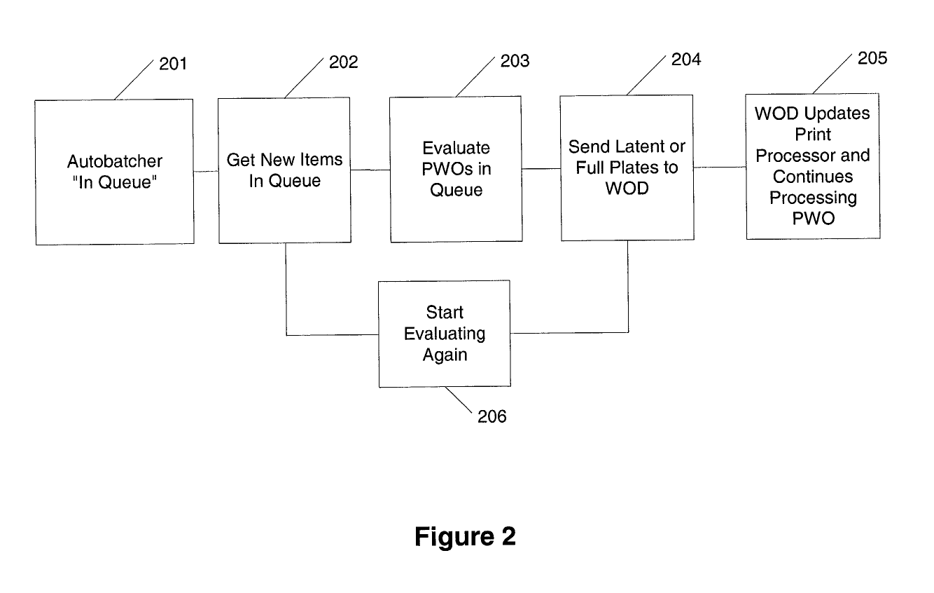

Referring to FIG. 2, for print work orders, one of the work centers is the autobatcher work center 108. The autobatcher work center obtains in step 202 the XML WO data in it from an input queue 201, evaluates (which may include reading an validating) the XML structure and/or the print work order in step 203, and begins processing on the work order. It uses the rules specified, as well as the immutable rules, to determine how long the work order can be held in the autobatching work center 108 (to wait for other similar other PWOs to batch with), what the PWOs inks are, the stock is, etc. It then batches the PWO either when the latency (or wait time) has expired or when the PWO can be combined with other PWOs (step 204) to reach maximum batching efficiency. In step 205, the WOD updates the print manager or print processor that the PWO has been processed. The autobatcher 108 continues evaluating for all new PWO's in step 206. Once the autobatcher receives a new PWO, it starts evaluating to see what kind of efficiency it can get for the PWO, what the latency time is, etc.

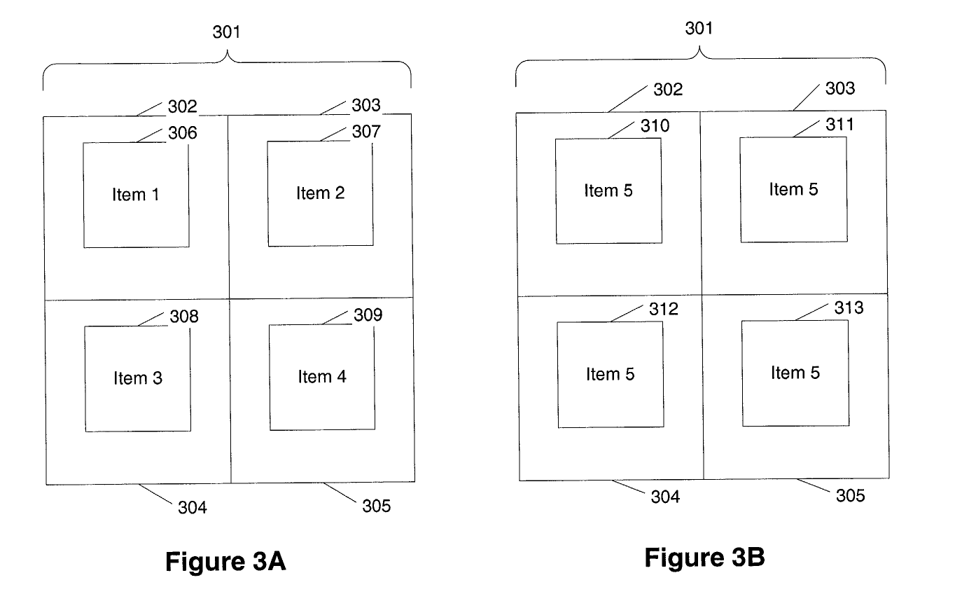

The autobatching center 108 addresses various issues. One issue addressed by the autobatching center 108 is addressing job latency in an automated print management system—in short, determining when a print job should be batched for press. The following is one example of how the autobatching work center 108 may determine latency. Other processes may be used. FIG. 3 is referred to for explanatory purposes.

Full plates achieve better efficiency. A full plate is a plate that holds a different order in each batch position. FIG. 3A shows a full plate 301. Here, each position 302-305 includes a different item (item 1 306, item 2 307, item 3 308, and item 4 309, respectively). FIG. 3B shown a not fall plate 301. Each of the four positions 302-305 contain the same item 5 in each position. Each item 5 is represented by the boxes 310-313.

Full plates are cheaper to print because the plate has a higher number of impressions, resulting in longer press runs, and therefore decreased number of press setup times. In the example of FIGS. 3A and 3B above, if the number of each item desired was 500 the Full Plate would be a press run of 500 impressions (4 items of 500 impressions divided by 4 positions=500). The Not Full Plate would be a press run of 125 impressions (1 item of 500 impressions divided by 4 positions=125).

The autobatching work center balances between two competing goals: to only output full plates and to complete work orders in a timely manner to satisfy the needs of the customers. To fulfill the first goal, one would need to wait until enough orders are received to complete a full plate and not release any plate until it is full. However, the finished product needs to be delivered to a customer in a timely fashion. Accordingly, a balance is struck between waiting until a plate is full and releasing a plate only when necessary to fulfill customer demands.

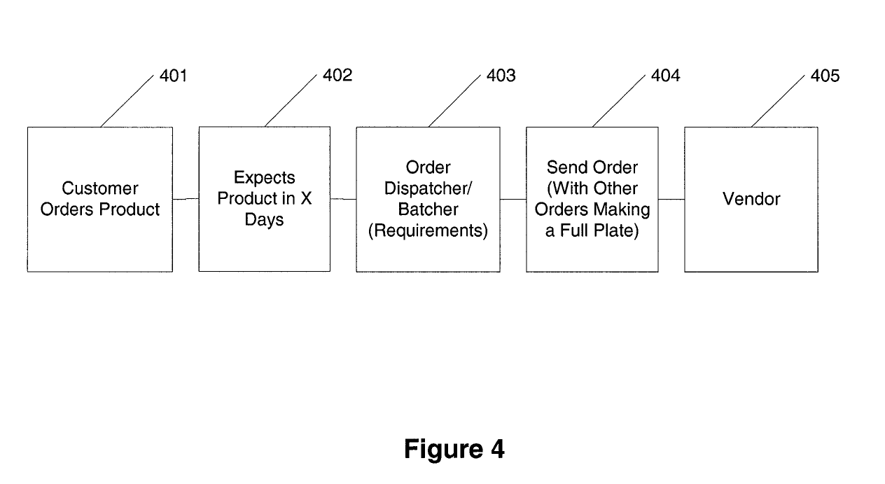

For example, Customer A orders product B. Customer A expects the product to be delivered in 5 days. The system should hold the order as long as possible (trying to batch the item with other items to create a full plate). However, one day is needed for delivery. FIG. 4 shows an example of a process flow for processing work orders to balance the need for a full plate and the need for meeting a customer's delivery time. In step 401, a customer orders a product (e.g., generates a work order). One of the conditions is that the customer expects the product in X days (requirement 402). The order dispatcher and autobatching work center attempt to complete a full plate in conjunction with the customer's requirements. Here, the autobatcher and/or the work order dispatcher hold the work order for X days minus the allotted delivery time. The allotted delivery time is the interval between completion of the printing process and delivery to the customer. In an alternative embodiment, printing time for the vendor may be included in the time determination of when to release the plate.

In step 404, the work order is sent to the vendor (as part of a full plate or part or all of a not full plate). In step 405, the work order is received and processed by the vendor.

If the autobatching work center 108 is separate from the work order dispatcher 103, the autobatching work center 108 by wait until it receives new work orders to analyze them. Alternatively, autobatching work center 108 may regularly or constantly poll the work order dispatcher 103 to determine if new work orders have been received. Further, the autobatching work center 108 may be combined with the work order dispatcher 103 to facilitate faster determination of whether new work orders are available for autobatching. Also, the autobatching work center may receive a notice of uncompleted work orders (or work orders yet to be determined if completed or not) from work order gather 104 and/or work order gathering queue 102 to permit autobatcher 108 to determine if it should wait a little longer for a new work order for possible batching rather than releasing a non full plate.

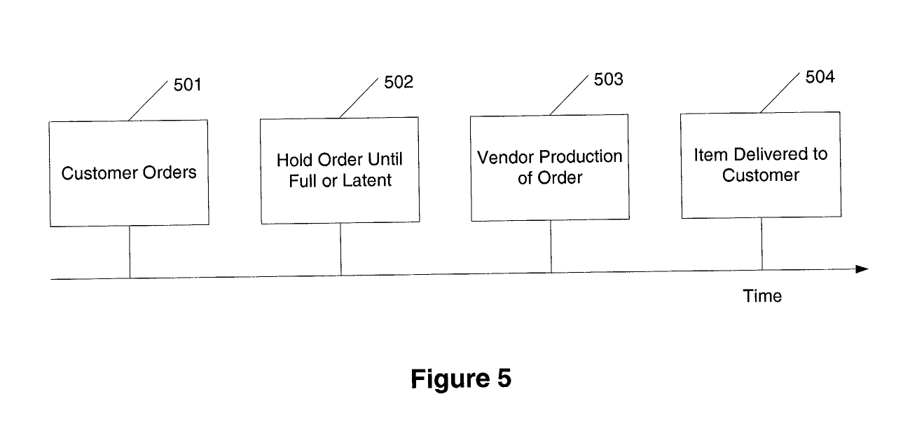

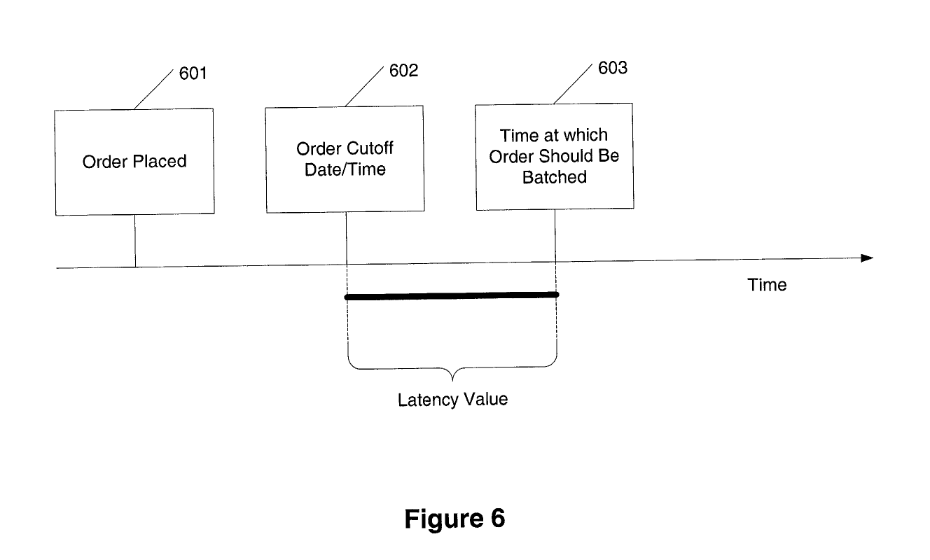

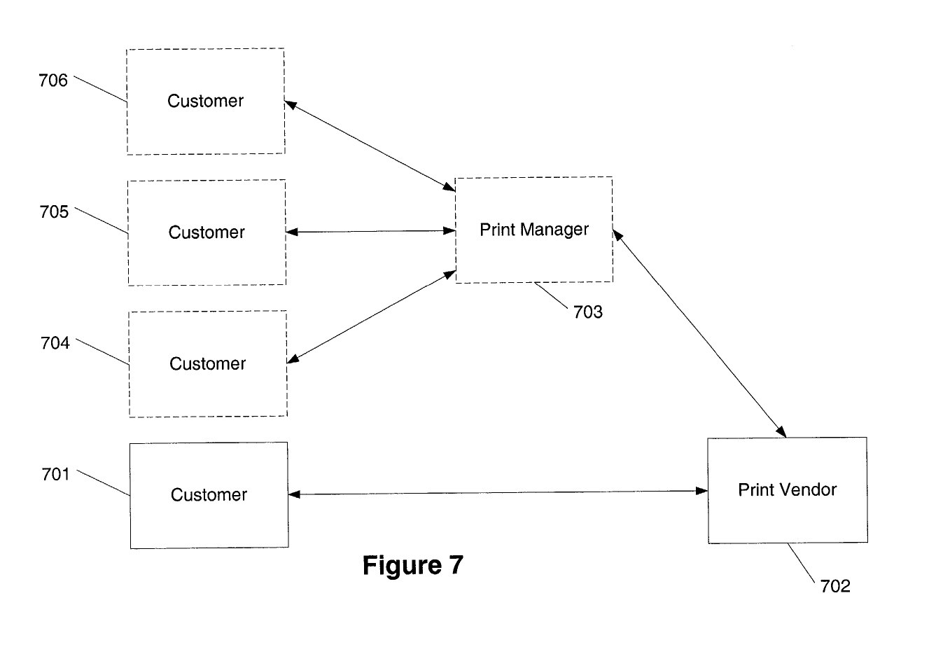

FIGS. 5 and 6 show various timings of work order handling in accordance with aspects of the present invention. In FIGS. 5 and 6, the not full plates are held until a certain time period has elapsed before a not full plate is released. FIG. 5 shows the general workflow of a customer orders in 501, the order is held in 502 until it is full or latent, in 503 the vendor produces the order, then in 504 the completed item is delivered to the customer.

In one embodiment, all orders may be held for the time period to see if they can be better matched with other orders. The time period is referred to as latency. In another embodiment, if the order can be batched to a full plate before the order is latent, the autobatcher batches the order with the other orders and releases the plate.

The latency period may vary based on various requirements including the customer's desired processing time (rush, standard, etc.). The latent time at which the autobatcher 108 releases the not full plate having the work order may be determined as an order cutoff date and time plus a latency value. The latency value

Latency is calculated using a latency value, an order date/time, and a cutoff time.

Latent Date/Time For An Order=Next Cutoff Order Date+Latency Value in minutes

So for an order placed at 11:00 am and the next cutoff time is 12:00 pm (for example for a rush order), and the latency value is 10 minutes, the resulting time at which the autobatcher would release the order if not full by 12:10 pm.

If the order is placed before the ordering cutoff time on a given day, the order is considered ordered on the present day. The latency value is added to the present day's cutoff time to find the item's Latent date/time. If the order is placed after the cutoff time on a given day, the order is considered ordered the next day. The latency value is added to the next day's cutoff time to find the item's Latent date/time.

In another example, order A is ordered Oct. 11, 2002 at 9 am. The cutoff time for Order A is 10 am. The latency value for Order A is 10 minutes. The latent date/time for Order A is Oct. 11, 2002, 10:10 am.

Order B is ordered Oct. 11, 2002 at 10:15 am. The cutoff time for Order B is 10 am. The latency value for Order B is 10 minutes. The latent date/time for Order A is Oct. 12, 2002, 10:10 am. Notice that the latent value for the item is on the day after it was ordered. This is a result of being ordered after the cutoff time on the ordering day.

FIG. 6 shows a graphical representation of this determination. Time 601 is when an order is placed. The next order cutoff date and time 602 is determined. The latency value is added to the next order cutoff time resulting at the time at which the order should be batched 603.

Appendix A shows various XML structures for a work order including routing information, rules, and batching data.

Appendix B shows a code sample for a processing loop and rule evaluation for the autobatcher 108.

Benefits of using the autobatcher include one or more of the following:

1. Batching may be combined with other prepress applications while manual batching by human hands is error prone and time consuming.

2. Consistent workflow for new work orders as information may be retrieved regarding previous processing and/or rules from storage (for example, database 105).

3. Batching of print ready files is performed quickly by a processor.

Auto Job Creation, the Grouping of Work Orders

Auto job creation is an automatic method of combining multiple work orders together in compressed files to reduce costs by sending multiple work orders to vendors at once. If each work order ordered from a workflow system is sent to the vendor alone, a vendor must process that plate file individually. Receiving high volumes of job files (packets of plate files) is not cost effective. If job files are combined and sent to a vendor at once, transportation overhead is reduced, shipping costs and shipping costs can be decreased. This reduces vendor costs significantly.

The act of combining multiple work orders into a job is referred to as job creation. The problem of combining multiple work orders is known in the manufacturing industry. Manual analysis and workflow controls are commonly used to allocate place multiple work orders into groups together. Automated job creation attempts to minimize manual input to the process.

In a workflow system of FIG. 1 above, work orders are sent to the job creation work center 110 so they may be combined with other work orders when possible. The job creation work center 110 holds work orders for a specified amount of time (determined using the required delivery date and an estimate for vendor production time) and combines WOs together when possible. After combining WOs into logical jobs the completed job creation work for the WOs is returned to the work order dispatcher completed work queue 112.

Manual setup of job creation is error prone, uneconomical, and very repetitive; and it cannot anticipate and work with the large volumes of work orders required in high volume throughput of custom work orders required by online work order management systems. The job creation work center 110 takes this repeatable process and automates it for use in such high volume systems.

The job creation work center 110 creates jobs through use of various rules. The rules may be all immutable or mutable. Further, a combination of both may be used. Immutable job creation rules are those rules that never change for all Work Orders. An example of an immutable job creation rules is that WOs must have the same vendor to be placed in a job together.

A list of immutable job creation rules may include one or more of the following (or none as long as the rule is immutable):

1. All jobs will hold work orders for one vendor.

2. All jobs will hold work orders part of the same bulk shipping group.

3. All jobs will hold work orders with the same product class (bc, stationary, rings, etc).

Mutable job creation rules are those rules that the system either can learn and implement or a user overrides. Some examples of mutable job creation rules are: WOs can be held by the system for a specific amount of time (waiting for other WOs that have compatible rules in order to create full jobs to increase efficiencies); WOs must be from the same customer (some customers have exceptionally high volume and need separated for billing or other reasons); and WOs must have the same estimated delivery date (again some customers wish their items ordered in a specific time period to arrive together). These rules are specified in the registry for the job creation WC (as preset defaults, as set by the user, or dynamically specified and loaded from the workflow software). Other rules can of course be added to suit the desired outcome.

A list of mutable job creation rules may include one or more of the following (or none as long as the rule is mutable):

1. Allow for flexibility to manage/define job creation by like customer.

2. Allow for flexibility to manage/define job creation by like rush flag

3. Allow for flexibility to manage/define job creation ripeness for work orders (calculated from the customer cutoff date/time).

4. Allow for flexibility to manage/define the maximum number of plates per job.

5. Allow for the setting of run times at a customer level. Latency and run-time may be mutually exclusive settings.

6. Allow for flexibility to manage/define the maximum number of work orders per job.

7. Allow for flexibility to manage/define whether a job creation packet's contents are zipped.

8. Allow for flexibility to manage/define the contents of the job packet.

A number of available software tools can be used to facilitate job creation in manufacturing systems. Compression software products such as winzip can be used to group work orders into jobs. Each of these software products are customizable and have their own quirks and eccentricities. Each of these tools requires a human to perform the logic of job creation. The user of the tool must decide whether a work order should be placed in a job now or later (for efficiency), what items can be placed in jobs together (and can't), etc., settings for selection of files, proofing needs, bill of materials, etc., are required to be chosen by the user and are proprietary to these systems.

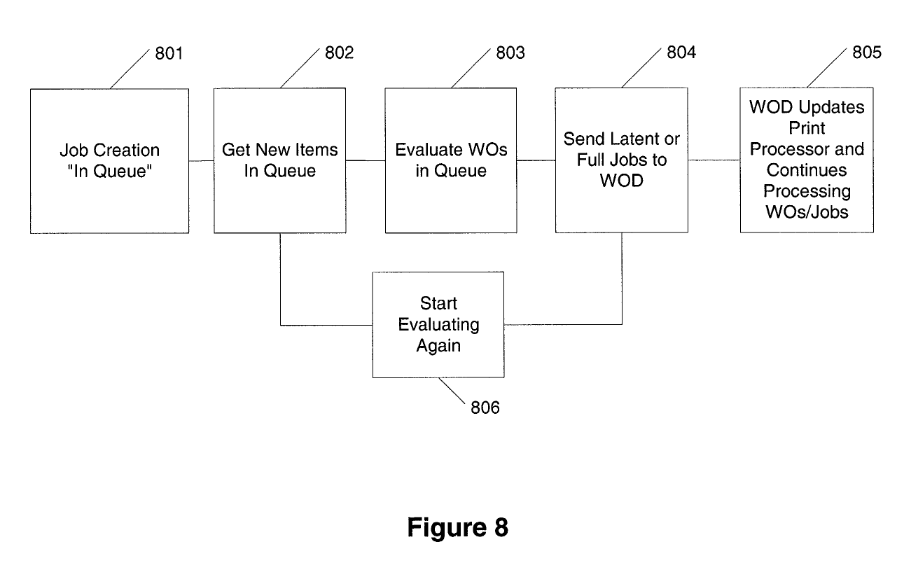

Referring to FIG. 1, most, if not all, work orders will eventually be routed to the job creation work center 110. Referring to FIG. 8, the job creation work center obtains WO data (for example, XML data) in step 802 from the job creation input queue 801. In 803, the received WO is evaluated (for example, the structure of the data is read and validated including if in XML). In step 804, the WO is processed with latent or full jobs sent to the WOD. The job creation center 110 uses the rules specified in the work order (for example), as well as other rules (for example, the immutable rules), to determine how long the work order can be held in the work center (to wait for other similar other WOs to group with), what the WOs vendor is, etc. It creates a job with the WO either when the latency (wait time) has expired or when the WO can be combined with other WOs to reach maximum job creation efficiency. The job creation work center then continues to evaluate new WOs in step 806 and updates a print monitoring system and continues processing new WOs/Jobs in 805. By controlling when WOs are combined into jobs that are sent to print vendors, the job creation work center solves at least one problem of automating workflow of printing systems.

As described above, Appendix A shows various XML structures that may be used with a work order.

Appendix C shows a portion of code for a job creation center processing loop and rule evaluation.

Benefits of using the job creation work center include one or more of the following:

1. May be hosted by a server application in an automated and scalable prepress management system.

2. Workflow is consistent among job creations and work orders as information may be retrieved from database 105.

3. Job creation may be performed quickly on print ready files with minimal to no operator intervention.

Work Order Dispatcher, the Distribution of Print Ready Files (Work Orders)

The work order dispatcher is an automatic method of distributing print ready files throughout internal and external work centers of a workflow system. A work center is considered any site where work is performed on a print ready file. Examples of work centers include: batching 108, trapping, translation (111), vendor job creation (110), and vendor job transfer. The work order dispatcher routes print ready files, using various routing structures (including but not limited to XML) (to allow for a different order of work performed on the print ready file), through work centers automatically. The WOD may be applied to other workflow systems through an API.

Work order dispatcher facilitates the internal processing of various prepress operations. It routes print ready files to each of the prepress work centers, receives completed work from these work centers, then updates the work order database 105 with the completed work on the print ready files. In this manner, the work order dispatcher may be considered a workflow tool that to load balances print ready files.

A number of available software workflow tools can be used to route work through systems. Software products such as Wang Open Workflow, and others, each have their own quirks and eccentricities. Settings for routing, method of transfer, etc. are proprietary to these third-party systems. Such systems are not based on open standards for process and applications control, or for data exchange. The WOD may be based on open standards including XML and the like.

The work order distribution workflow process is as follows: routing settings (along with other work order settings) for a client application may be pulled from work order database 105 by the WOD gatherer 104. The WO data is placed in the WOD distribution queue 106. The WOD distribution component 107 reads the routing structure (for example, in XML or the like) for the WO data placed in the WOD distribution queue 106 and sends the WO data to appropriate work centers.

Appendix D includes a sample partial XML structure for a work order (including routing information).

Appendix E shows a sample of HTTP IIS Distribution Code that may be used to distribute the work order data:

Benefits of using the work order dispatcher include one or more of the following:

1. Automated distribution of work orders by a scaleable, hosted server application.

2. Standard, consistent workflow.

3. Fast handling of large print ready files.

Alternative embodiments are possible. For example, the autobatching engine may be pushed to the print vendor where the print vendor performs autobatching at its location. Also, the client may combine work orders using an autobatcher prior to sending the work orders to the work order distribution center. Further, new rules may be added to the rules lists and saved for future applications.

While exemplary systems and methods embodying the present invention are shown by way of example, it will be understood, of course, that the invention is not limited to these embodiments. Modifications may be made by those skilled in the art, particularly in light of the foregoing teachings. For example, each of the elements of the aforementioned embodiments may be utilized alone or in combination with elements of the other embodiments. Although the invention has been defined using the appended claims, these claims are exemplary in that the invention is intended to include the elements and steps described herein in any combination or sub combination. Accordingly, there are any number of alternative combinations for defining the invention, which incorporate one or more elements from the specification, including the description, claims, and drawings, in various combinations or sub combinations. It will be apparent to those skilled in the relevant technology, in light of the present specification, that alternate combinations of aspects of the invention, either alone or in combination with one or more elements or steps defined herein, may be utilized as modifications or alterations of the invention or as part of the invention. It is intended that the written description of the invention contained herein covers all such modifications and alterations.

[image]

[image]

[image]

[image]

[image]

[image]

[image]

[image]

[image]

[image]

[image]

[image]

[image]

We claim:

1. A system for batching two or more work orders, each of said work orders having characteristics, said system comprising:
a queue receiving said two or more work orders;
a processor that combines said two or more work orders in accordance with rules;
an output for sending the combined work order.

2. The system according to claim 1, wherein said queue receives said two or more work orders from a work order dispatcher and said output outputs said combined work order to said work order dispatcher.

3. The system according to claim 1, wherein said processor combines said two or more work orders in accordance with both immutable and mutable rules.

4. A method for batching two or more work orders comprising the steps of:
receiving said two or more work orders;
combining said two or more work orders based on rules;
outputting a combined work order.

5. A work order dispatcher comprising:
a gathering component that receives work orders from a gathering queue and outputs said work orders to a distribution queue;
a distributor that receives said work orders from said distribution queue and forwards said work orders to one or more work centers;
a completed work receiver that receives work orders having been processed by said one or more work centers;
a workflow update component that updates a database of processing of said work orders based on processing from said one or more work centers.
